(19) United States
(12) Patent Application Publication
(10) Pub. No.: US 2007/0130913 A1
(43) Pub. Date: Jun. 14, 2007

(54) Coaxial propulsion systems with flow modification element

(76) Inventor: Howard Harrison, Mississauga (CA)

Correspondence Address: Distributed Thermal Systems Ltd., 2914 South Sheridan Way, Suite 100, Oakville, ON, L6J7L8, CA

(21) Appl. No.: 10/579,464

(22) PCT Filed: Nov. 18, 2004
(86) PCT No.: PCT/CA04/01927

§ 371 Date: May 17, 2006

(30) Foreign Application Priority Data
Nov. 18, 2003 (US) 60520677

(51) Int. Cl. F02K 3/04

(52) U.S. Cl. 60/226.3

(57) ABSTRACT

A coaxial propulsion system has a primary propeller, a flow control element to reduce swirl, and a secondary propeller, mounted in series configuration. A connecting shroud directs the combined thrust. Said primary propeller and said secondary propeller may be connected to the same engine, or independent engines for greater reliability and performance. A coaxial jet fan system has a primary fan, a flow control element to reduce swirl, and a secondary fan, mounted in a series configuration. A connecting shroud directs the combined bypass and jet thrust. Further, a secondary shroud provides a primary bypass and a secondary bypass thrust, thereby establishing a greater level of control over the bypass ratio and engine efficiency.

### PRIORITY

This application claims priority from US 60/520,677 (High Performance Coaxial Propulsion Systems) filed Nov. 18, 2003.

### FIELD OF THE INVENTION

This invention relates to a unique configuration of coaxial propellers or fans with a flow modification element. The configuration utilizes a flow modification element or diffuser between the two propellers to reduce the swirl component of flow before it enters the second propeller, allowing the second propeller to operate at a level of efficiency which may approach or even exceed that of the first propeller. As a result, the configuration offers excellent performance in a compact format that retains the inherent fault tolerant benefits of propellers arranged in series. High throughput fans may be used in place of the propellers to further enhance the performance of the propulsion system.

### BACKGROUND

The need for high performance, compact, and fault tolerant propulsion systems has been constantly increasing throughout aviation history. Initially, high performance was associated almost exclusively with thrust and speed. However more recently these objectives have been balanced with other Initiatives to improve efficiency, from a fuel consumption perspective, and to reduce noise. In many cases compact size and light weight are also critical design factors.

The high performance coaxial propulsion systems of the present invention have been designed to achieve these multiple objectives in a balanced fashion.

### Operation

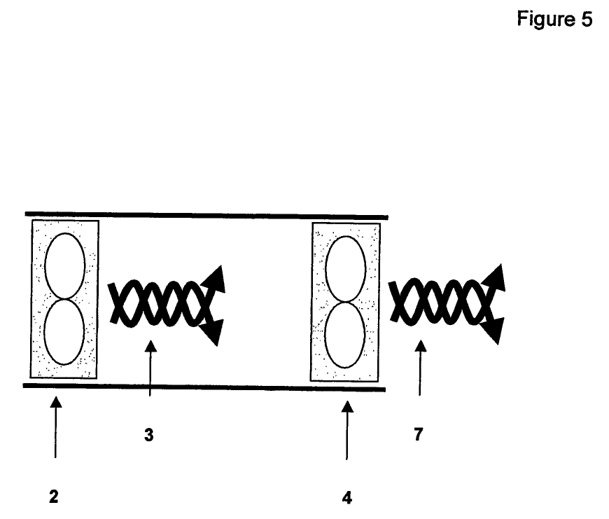

A propeller or axial fan works best if it sees a flow with no swirl on the input side. This condition is met with a single device since there is nothing on the input side to generate swirl. However this is not the case with a normal series configuration since the output of the first propeller or fan unfortunately has a swirl component as depicted in FIG. 5, which depicts coaxial propellers or fans in an inefficient configuration (with reference to the following components and corresponding numbers).

| Component | Number |
|---|---|
| Primary propeller or fan | 2 |
| Primary air flow with swirl | 3 |
| Secondary propeller or fan | 4 |
| Secondary air flow with swirl | 7 |

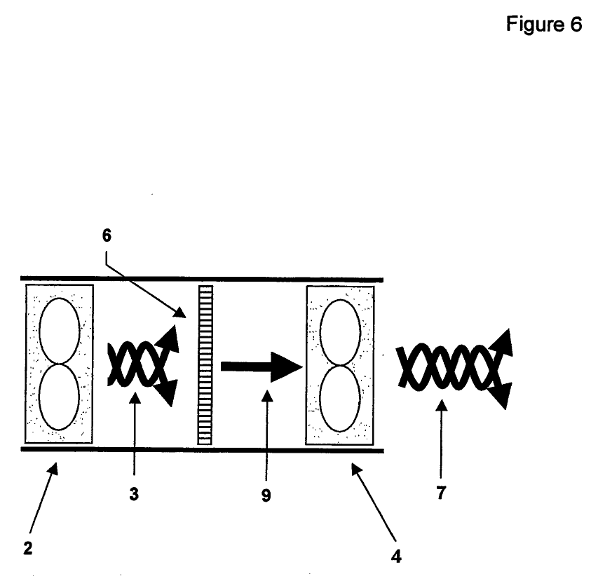

This problem may be resolved by placing a flow control element, or diffuser, between the two propellers or fans, the result of which is to reduce or substantially remove swirl from the air flowing into the secondary propeller or fan. This increases the efficiency of the secondary propeller or fan to a level approaching that of the primary propeller or fan, creating an efficient series configuration as depicted in FIG. 6 (with reference to the following components and corresponding numbers).

| Component | Number |
|---|---|
| Primary propeller or fan | 2 |
| Primary air flow with swirl | 3 |
| Secondary propeller or fan | 4 |
| Flow control element | 6 |
| Secondary air flow with swirl | 7 |
| Air flow with reduced swirl | 9 |

The flow control element, or diffuser element, may be designed to have a number of open channels aligned with the desired flow. Simplistically this may be visualized as a number of tubes aligned with the axis of the propellers or fans, and arranged to cover the cross section of the flow channel. However many designs are possible, and the diffuser element should be carefully optimized for any given application in order to maximize the reduction of swirl and minimize incremental drag within the required operating range(s). In some applications it may also be feasible to design the diffuser element surfaces to contribute to lift, however the increased impact on drag must also be taken into account.

The diffuser element may be most effectively placed at a distance from the primary propeller or fan, i.e. after some of the swirl produced by the primary propeller or fan has naturally subsided. The natural rate of reduction of swirl, without the aid of the diffuser, will be relatively rapid immediately after the primary propeller or fan, especially in ducts or shrouds with interior features configured to “straighten” the flow. Further, the amount of swirl as seen at the input of the diffuser element may be reduced, for a given flow rate, by applying more power to the secondary propeller or fan relative to the primary propeller or fan in order to increase the “pull” effect of the secondary propeller or fan relative to the “push” effect of the primary propeller or fan.

A fundamental benefit of the coaxial propulsion system is that it is compact, and it may be used to efficiently produce a level of thrust equivalent to that of a much larger single propeller or fan. Of note is the fact that the diameter of the propellers used in the coaxial propulsion system is much smaller than that of a single propeller that would be required to produce the same thrust. As a result, the rotational speeds of the propeller tips within a coaxial propulsion system are lower, producing less noise and allowing a greater level of thrust to be produced before encountering problems related to transonic propeller tip speeds.

The propellers or fans within a coaxial propulsion system may be of similar fixed pitch, different fixed pitch, or variable pitch. In configurations with one or more variable pitch propellers, the pitch(es) may be changed while in flight to maintain a relatively constant engine rpm. Further, the variable pitches may be controlled such that the secondary propeller or fan contributes relatively more thrust than the primary propeller or fan, taking advantage of the incremental efficiencies related to “pulling” rather than “pushing” air through the diffuser. In configurations with different fixed pitch propellers, the two fixed pitches may be selected to provide reasonable performance over a range of engine rpm's and aircraft speeds.

The preceding FIGS. A and B may also be used to illustrate the impact of a fan failure. If the primary propeller or fan fails, then the secondary propeller or fan will continue to draw air through the diffuser element and “push” it in the same direction to produce thrust in a consistent direction. A similar result will occur if the secondary propeller or fan fails, except that the air will be “pushed” rather than “pulled” through the diffuser element. This consistent direction of thrust, even in the event of a propeller or fan failure, is a fundamental advantage of a coaxial propulsion system since any corrective action required by the pilot and/or the related control systems will be minimized. This advantage may be fully realized in configurations where each propeller or fan is driven by an independent engine.

Although the direction of thrust will remain consistent in a coaxial propulsion system with a single propeller or fan failure, the level of thrust will be reduced if the remaining propeller or fan continues to operate at the same speed and pitch. This is an acceptable situation only if the level of thrust does not fall below the minimum required to maintain flight and/or meet current requirements. In practice a control system may be used to sense the propeller or fan failure and adjust the remaining propeller or fan speed accordingly, in order to ensure that this minimum thrust requirement is met. Again, a minimum level of pilot intervention may be required throughout this process due to the consistent direction of the thrust.

The above principle may also be used during normal operation to rapidly adjust the output of a coaxial propulsion system. As an example, one of the propellers or fans may be disconnected from a drive shaft to either (i) reduce the output of the propulsion system at a given engine rpm, or (ii) maintain the output of the propulsion system at relatively the same level while increasing the engine rpm. The first example may be used to reduce the bypass thrust in a jet fan engine, thereby reducing the bypass ratio and reducing the overall efficiency of the propulsion system to the extent that afterburners could be implemented on what is normally a high bypass engine. The second example could be used to increase engine rpm levels to efficient levels during intervals of lower thrust requirements. This is similar to the constant rpm principle behind a variable pitch propeller, except that it provides the ability to control thrust over a much wider range (e.g. cruise vs. acceleration) while keeping engine rpm relatively constant. Further, this ability to disconnect one of the propellers may be combined with one or more variable pitch propellers to provide a finer level of adjustment and greater efficiency over a wide operating range.

### EMBODIMENTS

Embodiments of the invention are described by way of example with reference to the drawings in which:

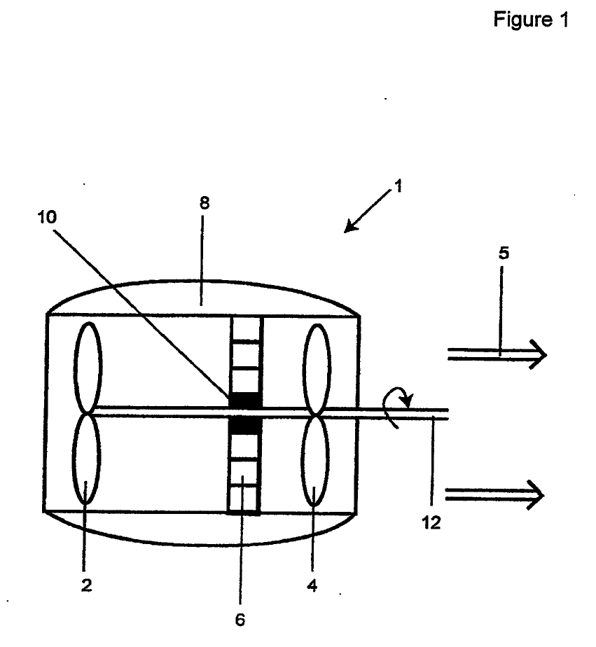

FIG. 1 provides a section view of a high performance coaxial propulsion system,

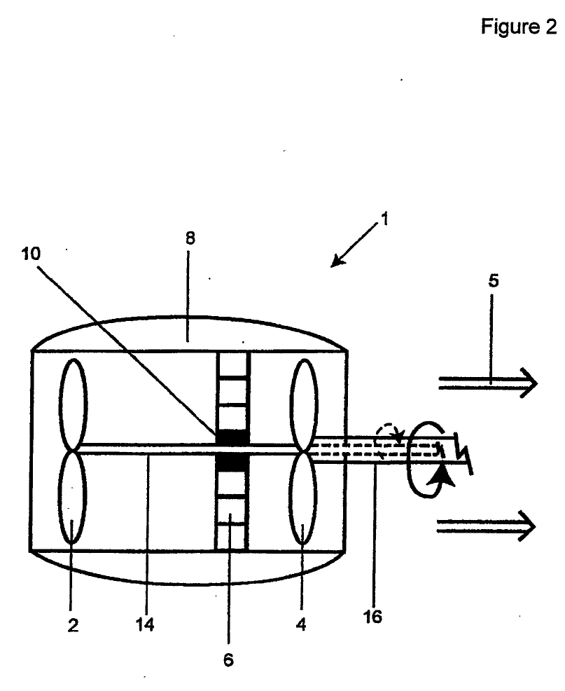

FIG. 2 provides a section view of a high performance coaxial propulsion system with independently driven propellers,

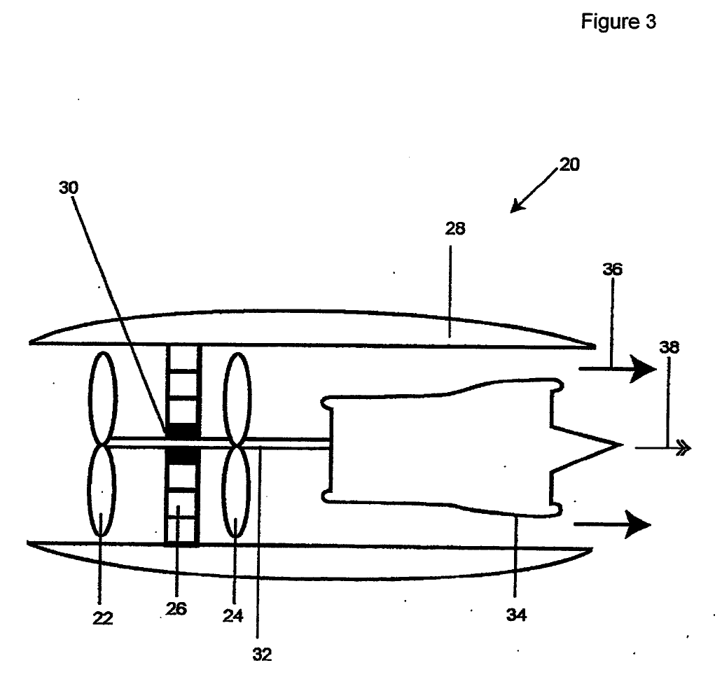

FIG. 3 provides a section view of a high performance coaxial jet fan configuration, and,

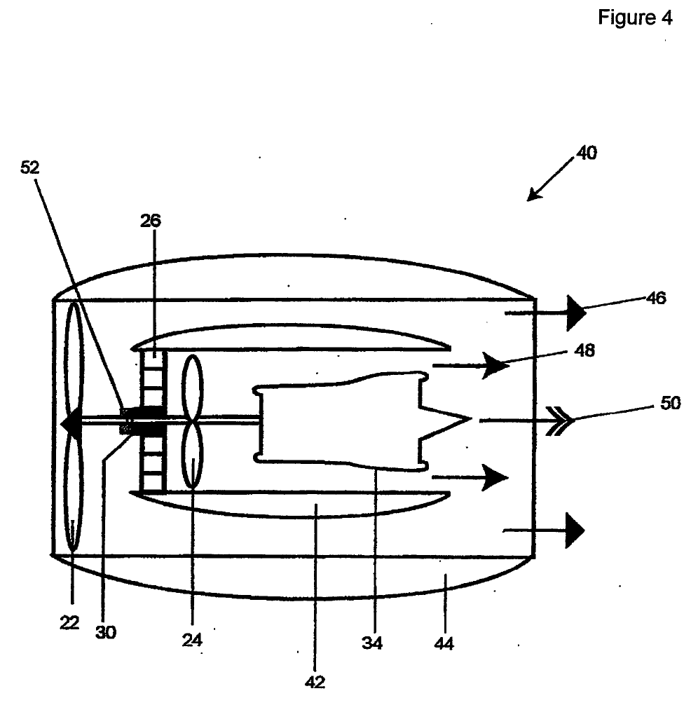

FIG. 4 provides a section view of a variable bypass high performance coaxial jet fan configuration with dual shrouds.

FIG. 1 provides a section view of high performance coaxial propulsion system 1 with primary propeller 2 and secondary propeller 4. In this configuration primary propeller 2 and secondary propeller 4 are rotated coaxially, and in the same direction, by single drive shaft 12 to produce thrust 5.

Flow control element 6 is positioned downstream from primary propeller 2 in order to substantially remove the swirl component from the flow generated by primary propeller 2, resulting in the efficient operation of secondary propeller 4. Flow control element 6 may be positioned a distance from primary propeller 2 in order that some initial reduction of swirl may take place prior to flow control element 6. Flow control element 6 may be positioned relatively closer to secondary propeller 4 since a substantial amount of swirl will have already been removed from the flow as it leaves flow control element 6, and a further separating distance would have a minimal effect on further reductions of swirl.

However it has been observed that a small distance between flow control element 6 and secondary propeller 4 reduces the acoustic noise produced by high performance coaxial propulsion system 1.

Flow control element 6 may be configured with horizontal sections that are designed to create additional lift while simultaneously reducing swirl. However the benefits associated with this design must be weighed against the incremental drag introduced by the lift producing sections of flow control element 6. Various other features, such as enhanced stability or engine heat transfer, may be incorporated into flow control element 6 as long as the impact of the increased drag on overall performance is recognized and accounted for.

Primary propeller 2 and secondary propeller 4, when configured with flow control element 6 in this manner, may produce a level of thrust 5 which approaches the maximum level of thrust possible with two independent propellers similar to primary propeller 2 and secondary propeller 4, i.e. the theoretical two propeller limit, since both propellers are operating efficiently. As a result, thrust 5 may be produced with two propellers having a much smaller diameter than the single propeller that would be required to produce the same level of thrust. This reduces the rotational speeds required to produce a given level of thrust, therefore making higher aircraft speeds possible without encountering transonic propeller tip issues. The reduced rotational speeds will also contribute to lower noise levels over a range of aircraft speeds.

Primary propeller 2 and secondary propeller 4 may be of the same or different fixed pitches. Alternatively, one or both of primary propeller 2 and/or secondary propeller 4 may be of variable pitch design. In either case, the use of a different pitch on primary propeller 2 relative to secondary propeller 4 may result in improved performance over a certain range of flight conditions relative to a single propeller design. Further one propeller may be maintained at a slightly higher pitch than the other propeller, at all times, in order to take advantage of the higher efficiencies associated with the former, in this configuration.

Primary propeller 2, secondary propeller 4, flow control element 6, and drive shaft 12 are surrounded by shroud 8. Shroud 8 is open at the front, to allow air to flow into primary propeller 2, and open at the back, to allow for the production of thrust 5. Shroud 8 may be constructed and designed to reduce the speed of the airflow entering primary propeller 2, relative to that of the aircraft, limiting the local Mach number on each primary propeller tip, and therefore allowing higher primary propeller 2 rotational speeds before Mach limitations are reached. Further, shroud 8 may be designed to contain the flow, with interior features such as longitudinal ridges designed to reduce swirl as the flow moves from primary propeller 2 to flow control element 6, and efficiently produce thrust 5 while having a minimum effect on drag. Further, shroud 8 may be constructed of sufficiently sturdy materials to contain or slow down a broken propeller blade, thereby increasing the safety of the propulsion system.

Flow control element 6 may be constructed with an integral shaft bearing 10, providing support for single drive shaft 12 while allowing it to rotate, and allowing for closer tolerances in the gap between the primary propeller 2 blade tips and shroud 8, and the secondary propeller 4 blade tips and shroud 8. This will substantially eliminate end losses due to air slipping over the tips of primary propeller 2 and secondary propeller 4.

FIG. 2 provides a section view of a high performance coaxial propulsion system 1 with independently driven propellers. This is made possible by two coaxial drive shafts, primary drive shaft 14 and secondary drive shaft 16, connected to primary propeller 2 and secondary propeller 4, respectively. Primary drive shaft 14 is free to rotate within secondary drive shaft 16, in the same or opposite rotational direction. Of note is the fact that primary drive shaft 14 may rotate at a different speed than secondary drive shaft 16, even when they are rotating in the same direction. This allows additional power to be applied to the more efficient secondary fan, increasing the overall efficiency of high performance coaxial propulsion system 1.

FIG. 2 illustrates a configuration where primary propeller 2 and secondary propeller 4 rotate coaxially, but in opposite directions. Primary drive shaft 14 and secondary shaft 16 may be connected to one or two engines depending on the desired level of redundancy. A single engine configuration may use a gearbox/transmission arrangement to provide the required counter rotational forces. Alternatively, a twin engine configuration may use coaxial engines mounted behind the propellers, with a forward mounted secondary engine connected to secondary propeller 4 and a rear mounted primary engine connected to primary propeller 2, and with primary drive shaft 14 running through the length of the secondary engine and secondary shaft 16 to facilitate a mechanical connection between the primary engine and primary propeller 2. Alternatively, a twin-engine configuration may use two engines mounted side by side with some means of mechanical connection to primary drive shaft 14 and secondary drive shaft 16, or it may use any other suitable engine configuration.

It should be noted that a twin-engine configuration, connected to high performance coaxial propulsion system 1 with propellers rotating in the same or opposite directions, as described above, is fault tolerant in the event of a single engine failure. A single engine failure would cause either primary propeller 2 or secondary propeller 4 to stop rotating, leaving the other propeller, connected to the other engine, still in operation. The remaining engine and propeller would continue to produce thrust 5, in the same direction, albeit at a reduced level due to the fact that power is only provided by one of the two engines. In some applications a clutch mechanism may be configured in the composite drive shaft to automatically engage the propeller that is primarily associated with the faulty engine, thereby reducing the drag effects associated with a stalled propeller. Regardless of the fail over mechanism, the fact that the thrust is maintained in a consistent direction is significant since it will not cause any suddenly unbalanced forces on the aircraft, and it will reduce the level of corrective response required from the pilot and/or the associated control systems.

FIG. 3 provides a section view of high performance coaxial jet fan configuration 20. Primary fan 22 and secondary fan 24 may be connected to one or two jet engines 34, in a coaxial configuration, through jet fan drive shaft 32. Jet fan drive shaft 32 may be a single or composite shaft, as previously described. Primary fan 22 and secondary fan 24 may be configured to rotate in the same or opposite directions. Primary fan 22 or secondary fan 24 may be selectively disconnected from jet fan drive shaft 32 to control bypass thrust 36, and therefore to control the bypass ratio.

Jet fan diffuser 26 may be positioned between primary fan 22 and secondary fan 24 to substantially remove swirl from the air flowing from the former to the latter, and to increase the efficiency of the latter to approach that of the former, as previously described. Jet shaft bearing 30 fits within jet fan diffuser 26 to rotationally support jet fan drive shaft 32. Jet fan diffuser 26 may be advantageously designed to act as a macro filter to prevent birds and other debris from entering jet engine 34.

Jet fan shroud 28 contains and controls the output from primary fan 22 and secondary fan 24 to produce bypass thrust 36, which combines with jet thrust 38, produced by jet engine 34, to produce the total thrust developed by high performance coaxial jet fan configuration 20. Bypass thrust 36 exceeds that possible with a single fan design having the same diameter, and approaches that possible with a single fan design having a much larger diameter, as previously described. It follows that this configuration produces a substantially higher level of bypass thrust 36, and therefore a higher bypass ratio, for a given jet fan shroud 28 diameter. As a result, the overall efficiency of high performance coaxial jet fan 20 is higher than that possible with a single fan configuration having the same jet fan shroud 28 diameter. Acoustic noise is lower than that produced by previous designs, which were configured with an external fan, since primary fan 22 and secondary fan 24 are both contained within jet fan shroud 28.

FIG. 4 provides a section view of variable bypass high performance coaxial jet fan 40 with dual shrouds—inner jet fan shroud 42 and outer jet fan shroud 44. Primary fan 22 and secondary fan 24 are mounted coaxially, however in this case the diameter of primary fan 22 exceeds that of secondary fan 24 such that primary bypass thrust 46 is only produced by primary fan 22, and such that secondary bypass thrust 48 is produced by the series combination of primary fan 22 and secondary an 24. Primary bypass thrust 46 and secondary bypass thrust 48 combine to produce the total bypass thrust for variable bypass high performance coaxial jet fan 40. In this case the total thrust developed by variable bypass high performance coaxial jet fan 40 is comprised of primary bypass thrust 46, secondary bypass thrust 48, and jet/after burner thrust 50.

Primary bypass thrust 46 may be substantially eliminated by disengaging clutch 52 and disconnecting primary fan 22 from jet engine 34. Alternatively, primary bypass thrust 46 may be reduced or increased by replacing clutch 52 with a variable speed transmission designed to control the speed of primary fan 22. Changing the speed of primary fan 22 will also cause a change in secondary bypass thrust 48, since it will change the flow of air through jet fan diffuser 26, however, secondary bypass thrust 48 will always be produced as long as secondary jet fan 24 remains operational.

The ability to control the level of bypass thrust in this manner presents the opportunity to control the efficiency of variable bypass high performance coaxial jet fan 40 over a wide operating range, from take-off to cruising speed. A maximum level of thrust may be achieved by disengaging primary fan 22 to minimize primary bypass thrust 46. This mode may be used to intentionally increase the amount of surplus fuel in the jet engine 34 exhaust stream, and enable the use of afterburners to produce a much higher level of jet/after burner thrust 50. Conversely, maximum efficiency may be achieved by fully engaging primary fan 22 to produce a maximum level of primary bypass thrust 46, and this mode may be used to reduce fuel consumption while cruising.

The present invention may be embodied in other specific forms without departing from the spirit or essential characteristics thereof. Certain adaptations and modifications of the invention will be obvious to those skilled in the art. Therefore, the above-discussed embodiments are considered to be illustrative and not restrictive, and any and all changes that come within the meaning and range of equivalency of the embodiments are therefore intended to be embraced therein.

We claim:

1. A coaxial propulsion system comprising;
a. An engine
b. A primary propeller;
c. A secondary propeller, in series with said primary propeller;
d. A flow control element; configured to remove swirl and mounted between said primary propeller and said secondary propeller;
e. A shroud,
wherein said shroud directs the output of said primary propeller through said flow control element and into said secondary propeller.

2. A coaxial propulsion system as claimed in claim 1 wherein said shroud further directs the thrust developed by said coaxial propulsion system.

3. A coaxial propulsion system as claimed in claim 1 wherein said engine is connected to said primary propeller and said secondary propeller through a common drive shaft.

4. A coaxial propulsion system as claimed in claim 1 wherein said drive shaft is rotationally supported by a bearing integral to said flow control element.

5. A coaxial propulsion system as claimed in claim 1 wherein said primary propeller and said secondary propeller rotate in the same direction.

6. A coaxial propulsion system as claimed in claim 1 wherein said primary propeller and said secondary propeller rotate in opposite directions.

7. A coaxial propulsion system as claimed in claim 1 wherein said flow control element is configured to substantially remove swirl from the airflow before it enters said secondary propeller.

8. A coaxial propulsion system as claimed in claim 1 wherein said flow control element is further configured to provide lift.

9. A coaxial propulsion system as claimed in claim 1 wherein said primary propeller and said secondary propeller may be of fixed or variable pitch.

10. A coaxial propulsion system as claimed in claim 1 wherein said secondary propeller may be maintained at a slightly higher pitch than said primary propeller to take advantage of the higher efficiencies associated with said secondary propeller.

11. A coaxial propulsion system as claimed in claim 1 wherein said secondary propeller is positioned a further distance from said flow control element to reduce acoustic noise.

12. A coaxial propulsion system as claimed in claim 1 wherein said primary propeller and said secondary propeller are fans.

13. A twin engine coaxial propulsion system comprising;
a. A primary engine;
b. A primary propeller;
c. A secondary engine;
d. A secondary propeller, in series with said primary propeller;
e. A flow control element configured to reduce swirl and mounted between said primary propeller and said secondary propeller;
f. A shroud,
wherein said shroud directs the output of said primary propeller through said flow control element and into said secondary propeller, and wherein said primary engine is connected to said primary propeller through a primary drive shaft and said secondary engine is connected to said secondary propeller through a secondary drive shaft.

14. A twin engine coaxial propulsion system as claimed in claim 13 wherein said shroud further directs the thrust developed by said twin engine coaxial propulsion system.

15. A twin engine coaxial propulsion system as claimed in claim 13 wherein said twin engine coaxial propulsion system is configured to maintain said thrust above a minimum level at all times, in the event of the failure of said primary propeller or said secondary propeller.

16. A twin engine coaxial propulsion system as claimed in claim 13 wherein said drive shafts are rotationally supported by a bearing integral to said flow control element.

17. A twin engine coaxial propulsion system as claimed in claim 13 wherein said primary drive shaft and said secondary drive shaft are coaxial.

18. A twin engine coaxial propulsion system as claimed in claim 13 wherein said primary engine and said secondary engine are coaxial.

19. A twin engine coaxial propulsion system as claimed in claim 13 wherein said primary propeller and said secondary propeller rotate in the same direction.

20. A twin engine coaxial propulsion system as claimed in claim 13 wherein said primary propeller and said secondary propeller rotate in opposite directions.

21. A twin engine coaxial propulsion system as claimed in claim 13 wherein said flow control element is configured to substantially remove swirl from the airflow before it enters said secondary propeller.

22. A twin engine coaxial propulsion system as claimed in claim 13 wherein said flow control element is further configured to provide lift.

23. A twin engine coaxial propulsion system as claimed in claim 13 wherein said primary propeller and said secondary propeller may be of fixed or variable pitch.

24. A twin engine coaxial propulsion system as claimed in claim 13 wherein said secondary propeller may be maintained at a slightly higher pitch than said primary propeller to take advantage of the higher efficiencies associated with said secondary propeller.

25. A twin engine coaxial propulsion system as claimed in claim 13 wherein said secondary propeller is positioned a further distance from said flow control element to reduce acoustic noise.

26. A twin engine coaxial propulsion system as claimed in claim 13 wherein said primary propeller and said secondary propeller are fans.

27. A coaxial jet fan system comprising;
a. A jet engine;
b. A primary fan;
c. A secondary fan, in series with said primary fan;
d. A flow control element configured to reduce swirl and mounted between said primary fan and said secondary fan;
e. A shroud, said shroud directing the output of said primary fan through said flow control element and into said secondary fan; said shroud further directing the bypass thrust and the jet thrust developed by said high performance coaxial jet fan system;
Wherein said jet engine is connected to said primary fan and said secondary fan through a common drive shaft.

28. A high performance coaxial jet fan system as claimed in claim 27 wherein said drive shaft is rotationally supported by a bearing integral to said flow control element.

29. The high performance coaxial jet fan system as claimed in claim 27 wherein said primary fan and said secondary fan rotate in the same direction.

30. The high performance coaxial jet fan system as claimed in claim 27 wherein said primary fan and said secondary fan rotate in opposite directions.

31. The high performance coaxial jet fan system as claimed in claim 27 wherein said flow control element is configured to substantially remove swirl from the airflow before it enters said secondary fan.

32. The high performance coaxial jet fan system as claimed in claim 27 wherein said flow control element is further configured to provide lift.

33. The high performance coaxial jet fan system as claimed in claim 27 wherein said primary fan and said secondary fan may be of fixed or variable pitch.

34. The high performance coaxial jet fan system as claimed in claim 27 wherein said secondary fan may be maintained at a slightly higher pitch than said primary fan to take advantage of the higher efficiencies associated with said secondary fan.

35. The high performance coaxial jet fan system as claimed in claim 27 wherein said secondary fan is positioned a further distance from said flow control element to reduce acoustic noise.

36. The high performance coaxial jet fan system as claimed in claim 27 wherein said primary fan or said secondary fan may be disconnected from said drive shaft to reduce said bypass thrust.

37. The high performance coaxial jet fan system as claimed in claim 27 wherein said jet engine may be two jet engines, and said drive shaft may be two drive shafts.

38. A variable bypass coaxial jet fan system comprising;
a. An jet engine;
b. A primary fan;
c. A secondary fan, in series with said primary fan;
d. A flow control element configured to reduce swirl and mounted between said primary fan and said secondary fan;
e. A primary shroud, said shroud directing the output of said primary fan through said flow control element and into said secondary fan; said shroud further directing the primary bypass thrust;
f. A secondary shroud, said secondary shroud directing the secondary bypass thrust; said secondary shroud further directing the jet thrust developed by said high performance coaxial jet fan system;
Wherein said jet engine is connected to said primary fan and said secondary fan through a common drive shaft.

39. The variable bypass coaxial jet fan system as claimed in claim 38 wherein said drive shaft is rotationally supported by a bearing integral to said flow control element.

40. The variable bypass coaxial jet fan system as claimed in claim 38 wherein said primary fan and said secondary fan rotate in the same direction.

41. The variable bypass coaxial jet fan system as claimed in claim 38 wherein said primary fan and said secondary fan rotate in opposite directions.

42. The variable bypass coaxial jet fan system as claimed in claim 38 wherein said flow control element is configured to substantially remove swirl from the airflow before it enters said secondary fan.

43. The variable bypass coaxial jet fan system as claimed in claim 38 wherein said flow control element is further configured to provide lift.

44. The variable bypass coaxial jet fan system as claimed in claim 38 wherein said primary fan and said secondary fan may be of fixed or variable pitch.

45. The variable bypass coaxial jet fan system as claimed in claim 38 wherein said secondary fan may be maintained at a slightly higher pitch than said primary fan to take advantage of the higher efficiencies associated with said secondary fan.

46. The variable bypass coaxial jet fan system as claimed in claim 38 wherein said secondary fan is positioned a further distance from said flow control element to reduce acoustic noise.

47. The variable bypass coaxial jet fan system as claimed in claim 38 wherein said primary fan may be disconnected from said drive shaft to reduce said primary bypass thrust.

48. The variable bypass coaxial jet fan system as claimed in claim 38 wherein said secondary fan may be disconnected from said drive shaft to reduce said secondary bypass thrust.

49. The variable bypass coaxial jet fan system as claimed in claim 38 wherein said jet engine may be two jet engines, and said drive shaft may be two drive shafts.
